(19) United States
(12) Patent Application Publication
(10) Pub. No.: US 2017/0326816 A1
(43) Pub. Date: Nov. 16, 2017

(54) SYSTEMS AND METHODS FOR VOLUMETRIC POWDER BED FUSION

(71) Applicant: Board of Regents, The University of Texas System, Austin, TX (US)

(72) Inventors: Carolyn Seepersad, Austin, TX (US); Joseph Beaman, Austin, TX (US); John Pearce, Austin, TX (US)

(21) Appl. No.: 15/595,233

(22) Filed: May 15, 2017

Related U.S. Application Data
(60) Provisional application No. 62/335,855, filed on May 13, 2016.

(51) Int. Cl. B29C 67/00

(52) U.S. Cl. CPC B29C 67/0077; B29C 67/0085; B29C 67/0081; B29C 67/0066; B29C 67/0092

(57) ABSTRACT

Various implementations utilize electromagnetic energy in the microwave and/or radio frequency (RF) spectrum to volumetrically solidify selective regions of a base material powder bed (e.g., polymer or ceramic). When they are dry, base materials utilized in powder bed fusion and other additive manufacturing processes are relatively transparent to microwave and RF energy, making it very difficult to heat them with those energy sources. However, mixing or doping the base material powders with conducting particles, such as graphite or carbon black, enhances energy absorption at microwave and radio frequencies, enabling heating and melting. Thus, volumetric additive manufacturing may be achieved by selectively doping a 3D powder bed with energy-absorbing particles in the shape of the desired object and exposing the powder bed to microwave and/or RF energy fields, such that the doped regions are volumetrically sintered into desired objects, leaving the surrounding powder unaffected.

### CROSS REFERENCE TO RELATED APPLICATION

This application claims priority to U.S. Patent Application No. 62/335,855, entitled “Systems and Methods for Volumetric Powder Bed Fusion,” filed May 13, 2016, the content of which is herein incorporated by reference in its entirety.

### BACKGROUND

Additive manufacturing (AM) is revolutionizing not only modern manufacturing but also the entire product development cycle, including the types of products that are designed and the supply chains through which they are delivered. By placing material only where it is needed, in an additive, layer-wise fashion, it is possible to create very complex architectures and functionally graded features that enhance the functionality of a product. By fabricating a part directly from a digital file, with no required tooling or fixtures, it is economical to fabricate parts locally in small quantities, opening the door to personal customization and one-of-a-kind fabrication and repair.

Private and public groups in the USA and the UK are recognizing the importance of AM to the strength, competitiveness, and growth of their economies. Game-changing technologies could accelerate that growth even more. One of the most significant barriers is the slow build speed of most AM technologies. New technologies for volumetric AM would help remove that barrier.

Although AM enables production of complex parts in small volumes, the slow speed and high cost of additively manufacturing a part—relative to high-throughput conventional manufacturing methods—are significant barriers to the growth of AM. The barriers are particularly acute for powder bed fusion processes. For example, selective laser sintering (SLS), one of the most broadly utilized AM technologies for end-use parts, requires more than 24 hours to fabricate a full batch of polymer parts occupying a build chamber volume of approximately 15 by 13 by 18 inches. Parts are built in layers—typically on the order of 100 microns thick—by sintering powders with a laser that traces successive cross-sections of the part in a raster-like pattern. Depending on the complexity of the cross-section, each layer can require 60 seconds or more to prepare and fabricate, resulting in build times of 24 hours or more. Combined with post-build cooling operations, the cycle time for a full build can approach 36 hours. Although recent technological advances have improved processing speed, these process improvements are still essentially fabricating objects in a layer-by-layer manner and are therefore inherently limited in terms of the speed with which they consolidate material.

Researchers are pursuing high speed additive manufacturing with technologies other than powder bed fusion. A particularly notable recent advance is the continuous liquid interface production (CLIP) technology introduced recently by Carbon3D, which cures a photosensitive resin continuously, from the bottom up, by transmitting selectively patterned UV light and oxygen through an oxygen permeable membrane as a curing agent and an inhibiting agent, respectively. Although the CLIP technology promises to increase the speed of pre-existing vat photopolymerization processes by an order of magnitude or more, it still approaches material deposition from a primarily 2D perspective (bottom-up). In that way, it is similar to mask-based photopolymer processes that have been researched extensively and commercialized by several companies (e.g., EnvisionTEC). In addition, the CLIP technology and mask-based photopolymerization approaches appear to be limited to vat photopolymerization of a single homogeneous material. Limiting the process to photosensitive resins severely curtails their applications for functional end-use parts because material properties are known to degrade significantly with time.

In commercial laser sintering systems, a laser selectively scans a cross-section of powder, adding enough thermal energy to selectively fuse powder particles into a solid part. This point-wise polymer processing is slow and contributes to the high cost of laser sintered parts. However, there have been many attempts to increase the processing speed of powder-based sintering systems, largely based on the concept of layer-wise processing to eliminate laser scanning time. For example, a high speed sintering (HSS) process jets an ink into the powder bed to preferentially absorb infrared energy over the whole layer in an instant. An alternative is to deposit an agent into the powder bed to inhibit sintering so as to control the areas where sintering does occur. A combination of both of these processes can be seen in HP's new Multi Jet Fusion™ technology. Another alternative is to use Digital Micromirror Devices (DMDs) to project energy onto the complete cross section that is desired.

Accordingly, there is a need in the art for a faster method of fabricating parts with powder bed fusion technologies.

### BRIEF SUMMARY

Various implementations include a method of producing a three-dimensional part using additive manufacturing. The method includes: (1) depositing a first layer of base material powder adjacent a support surface, the base material powder being substantially transparent to electromagnetic radiation; (2) depositing a dopant onto one or more selected areas of the first layer of base material powder, the one or more selected areas being areas for which fusion of the base material powder is desired, wherein the dopant absorbs electromagnetic radiation; (3) depositing one or more additional layers of base material powder until a desired height of the three-dimensional part is achieved, wherein the dopant is deposited on each layer in one or more selected areas for the respective layer for which fusion is desired; and (4) exposing the layers of base material powder and dopant to an electromagnetic radiation field, the electromagnetic radiation field having a wavelength frequency of between 3 kHz to 300 GHz, wherein the electromagnetic radiation field sinters the one or more selected areas of the base material powder layers on which the dopant is deposited to create the three-dimensional part.

In some implementations, the base material powder on which dopant is not deposited remains unsintered after exposure to the electromagnetic radiation field, and the method further includes freely removing the three-dimensional part from the unsintered base material powder after exposing the base material powder and dopant to the electromagnetic radiation field. For example, in certain implementations, freely removing the unsintered base material powder includes vacuuming the unsintered base material powder away from the sintered three-dimensional part or directing a pressurized gas toward the unsintered base material powder to blow the unsintered base material powder away from the sintered three-dimensional part.

In addition, in some implementations, a concentration of dopant is graded along edges of the part such that the graded areas are warmed during exposure to the electromagnetic radiation field but are not sintered.

Furthermore, in some implementations, the base material powder includes a polymer powder and/or glass fiber.

In certain implementations, depositing the dopant includes printing the dopant onto one or more base material powder layers using an ink-jet printing process. The dopant may be carbon black, iron, or aluminum, for example. In addition, in some implementations, the dopant is not applied to all areas of the base material powder.

In some implementations, a dissipation factor of the base material powder is 0.002 or less. In a further or alternative implementation, the dopant increases the dissipation factor of the base material powder on which the dopant is deposited to at least 0.04.

In some implementations, the wavelength frequency of the electromagnetic radiation field is between 300 MHz and 300 GHz.

Various other implementations include a system for producing a three-dimensional part using additive manufacturing. The system includes a build platform on which a base material powder is deposited layer by layer; a dopant dispenser comprising a dopant; and an electromagnetic wave generator. The base material powder is substantially transparent to electromagnetic radiation, the dopant absorbs electromagnetic radiation, the dopant dispenser is configured to deposit the dopant onto selected areas of an upper layer of the base material powder for which fusion is desired, the electromagnetic wave generator is configured to transmit an electromagnetic radiation field to a plurality of layers of base material powder and dopant, the electromagnetic radiation field having a wavelength frequency of between 3 kHz to 300 GHz, and the electromagnetic radiation field sinters the one or more selected areas of the base material powder layers on which the dopant is deposited to create the three-dimensional part.

In some implementations, the dopant dispenser is disposed above the build platform. And, in a further or alternative implementation, the electromagnetic wave generator is disposed adjacent the build platform.

In some implementations, the system also includes a powder feed bed on which the base material powder is disposed prior to be deposited onto the build platform and a powder spreader. The powder feed bed is movable vertically, and the powder feed bed is disposed adjacent the build platform. The powder spreader is movable horizontally between the powder feed bed to adjacent the build platform to move each layer of base material powder from the powder feed bed to the build platform or the upper layer of powder bed of the base material powder deposited on the build platform. The powder feed bed is movable upwardly and the build platform is movable downwardly by a height of each layer of base material powder ahead of the powder spreader moving each layer from the powder feed bed toward the build platform. For example, a height of the plurality of layers of base material powder and dopant are a desired height of the three-dimensional part.

### BRIEF DESCRIPTION OF THE DRAWINGS

FIG. 1 illustrates a method of producing a three-dimensional part using additive manufacturing according to one implementation.

FIG. 2 illustrates a resulting heating term Q_{gen} and e-field streamlines for an exemplary formed spherically shaped part.

FIG. 3 illustrates resulting temperature distributions for an exemplary formed spherically shaped part.

FIG. 4 illustrates a base material powder prior to sintering.

FIG. 5 illustrates an exemplary three dimensional part after sintering.

FIG. 6 illustrates a system for producing a three-dimensional part using additive manufacturing according to one implementation.

### DETAILED DESCRIPTION

Various implementations described herein provide truly volumetric powder bed fusion in which the entire 3D volume of the powder bed is fused synchronously. The implementations shift away from layer-based or 2D fabrication, which inherently limits production speed and other capabilities, such as the capability of building around inserts. Sintered parts are consolidated volumetrically, resulting in at least a 25× reduction in cycle time relative to commercial SLS. In addition, a wider variety of polymer and ceramic materials may be sintered using various implementations of the processes described herein.

Various implementations described herein utilize electromagnetic energy in the microwave and/or radio frequency (RF) spectrum to volumetrically solidify selective regions of a base material powder bed (e.g., polymer or ceramic). When they are dry, the base materials are relatively transparent to microwave and RF energy, making it very difficult to heat them with those energy sources. However, mixing or doping the base material powders with conducting particles, such as graphite or carbon black, enhances energy absorption at microwave and radio frequencies, enabling heating and melting. Thus, volumetric additive manufacturing may be achieved by selectively doping a 3D powder bed with energy-absorbing particles in the shape of the desired object and exposing the powder bed to microwave and/or RF energy fields, such that the doped regions are volumetrically sintered into desired objects, leaving the surrounding powder unaffected.

A challenge in this process is achieving uniform heating and dimensional control of the fabricated parts, even when those parts are large (on the scale of those fabricated in commercial selective laser sintering machines). However, various implementations provide reduced thermal gradients, resulting in improved part properties and a broader range of candidate materials, and at least 25× faster sintering cycles relative to existing powder bed fusion AM, due to the volumetric nature of microwave/RF heating.

Microwave and radio frequency (RF) energy penetrate into the build volume much more deeply than infrared energy, making it possible to sinter large volumes of material simultaneously, rather than sintering it on a layer-by-layer cycle. For example, infrared energy wavelengths are 1-10 microns, which typically penetrate a thermoplastic to a depth on the scale of microns, with further penetration occurring via conduction beneath the surface. Microwave and RF wavelengths, in contrast, are on the order of centimeters and meters, respectively, which means that they can penetrate much more deeply into the material with penetration depths on the order of centimeters and meters, respectively.

Some materials, such as the thermoplastics typically used in polymer sintering, are insulators that are essentially transparent to microwave and RF energy. For example, exemplary base material powders that may be used in polymer sintering include nylon, ABS, polyethylene, polypropylene, and polycarbonate. However, other materials, such as water or carbon black are much better absorbers of microwave and RF energy and easily heated. More specifically, dissipation factor is the ratio of a material's loss factor—which quantifies the material's ability to dissipate microwave energy as heat—to the material's dielectric constant, which quantifies the material's ability to retard microwave energy as it passes through the material. Materials with low dissipation factors dissipate relatively little microwave energy as heat (i.e., they are not easily heated by microwave energy). For example, at microwave frequencies, polymers typically exhibit dielectric constants in the range of 2 to 5 and dissipation factors on the order of 0.002. When carbon black, a potential dopant, is added to the polymer, the dielectric constant increases to approximately 10 to 15, and the dissipation factor increases to 0.04 to 0.06, which is 30 times higher than the polymer alone. Other potential dopants include iron and iron alloys, some metallic salts, and water and other liquids. Carbon-based materials, such as carbon black and graphite are particularly good absorbers across the microwave and RF spectrum. Because microwave heating is a volumetric process, which transfers energy selectively to dielectric absorbers, it is much more efficient and much faster than radiant heating.

Prior research in microwave/RF processing of materials has focused on making insulators more absorptive via the addition of lossy additives. Chemical companies (e.g., Dow Chemical Company in international patent application WO2007143019) use absorbing agents combined with microwave energy to melt plastics much more rapidly than with radiant energy. Carbon black is often added to various rubbers to enable efficient, high speed vulcanization. Carbon black is also added to insulating polymers to increase their electrical conductivity, which contributes significantly to the effective dielectric loss factor, especially at radio frequencies. These conductive polymers are often used commercially as antistatic materials, electromagnetic shielding materials, or piezoresistive materials for pressure sensors, switches, and other applications. Although it is known to dope plastics with conductive additives to enhance conductivity, effective dielectric loss factor, and other properties, none of these applications selectively dope plastic powders to melt or sinter them only in specific spatial domains of interest.

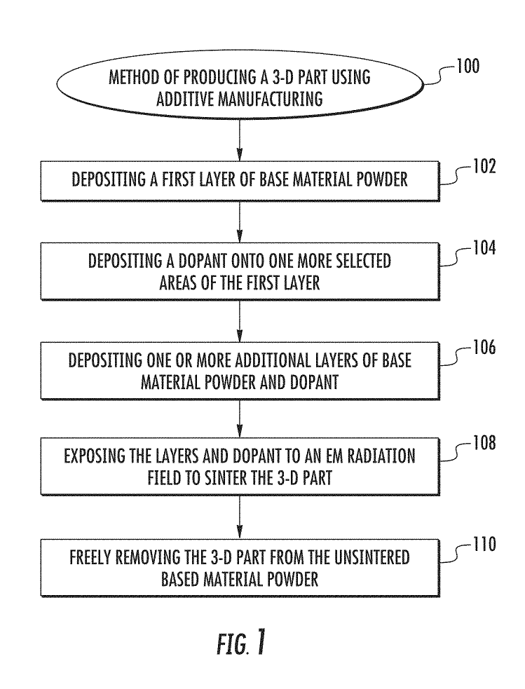

FIG. 1 illustrates an exemplary method of producing a three-dimensional part using additive manufacturing according to one implementation of the invention. The method 100 begins at step 102 by depositing a first layer of base material powder adjacent a support surface. As described above, the base material powder is substantially transparent to electromagnetic radiation. Next, in step 104, a dopant is deposited onto one or more selected areas of the first layer of base material powder. The one or more selected areas are those for which fusion of the base material powder is desired, and, as discussed above, the dopant absorbs electromagnetic radiation. In step 106, one or more additional layers of base material powder are deposited, and dopant is deposited on each additional layer in one or more selected areas for which fusion is desired until a desired height of the three-dimensional part is achieved. As described more below, the dopant may be deposited using an ink jet printing or other suitable printing process.

Then, in step 108, the layers of base material powder and dopant are exposed to an electromagnetic radiation field. The EM radiation field has a wavelength of between 3 kHz and 300 GHz. The EM radiation field sinters the one or more selected areas of the base material powder layers on which dopant has been deposited to create the 3D part. In addition, in certain implementations, the wavelength frequency of the EM radiation field may be selected to be within the microwave range (e.g., 300 MHz (wavelength of 1 meter) to 300 GHz (wavelength of 0.1 cm)).

Following step 108, the base material powder on which dopant was not deposited remains unsintered after exposure to the EM radiation field. In step 110, the 3D part is freely removed from the unsintered base material powder. Although the 3D part may have some unsintered base material powder clinging to it post EM-radiation exposure, this unsintered base material powder may be easily removed, for example, by vacuuming the unsintered base material powder away from the part or by directing pressurized gas toward the 3D part to blow the unsintered base material powder away from the sintered 3D part.

Prior applications of microwave/RF heating to additive manufacturing processes are rare and differ significantly from the various implementations described herein. For example, some prior applications coupled microwave sintering with 3D printing to fabricate porous ceramic tissue scaffolds. They used microwave heating to sinter green parts that were additively manufactured with a binder jetting process. They found that microwave heating produced scaffolds with higher density and mechanical strength, relative to conventional sintering. The rapid volumetric nature of microwave heating induced less thermal stress than conventional sintering and resulted in less micro-cracking. However, these methods required binders and a binder removal process. In contrast, the various implementations described herein sinter parts directly in a supporting powder bed, which eliminates the need for binders and binder removal processes and their effects on part properties.

Various implementations described herein minimize thermal gradients by supporting the part in a surrounding powder bed (e.g., the base material powders selected are extremely effective insulators). To the extent that some thermal gradients remain near the surface of the part and could prevent the outer surfaces of the part from fully sintering, the dopant density may be graded such that the material surrounding the part is warmed (but not enough to cause sintering) or by pre-adjusting the dimensions of the part to offset dimensional effects of shrinkage and over- or under-sintering, for example.

Selective microwave heating has been used to soften the joints of additively manufactured origami parts, so that they can be folded and manipulated after fabrication. Specifically, an absorptive liquid with a higher boiling point than water (e.g., honey) was applied to the joints of a low absorption ABS part, and the microwave heating selectively softened the joints. However, lack of uniform heating in a conventional microwave made it difficult to heat large areas uniformly.

To counteract this effect, various implementations may include custom-built waveguides that provide more uniform electromagnetic fields and/or RF applicators that can provide effectively uniform electromagnetic fields throughout the powder bed. Also, RF wavelengths are orders of magnitude longer than those of microwaves (on the order of 10 m versus 10 cm), resulting in fewer hot and cold spots associated with constructive or destructive interference, respectively.

A prior art selective inhibition sintering (SIS) process outlines the part geometry with a material that inhibits sintering, so that the sintered part can be separated from the surrounding structure, with inhibitor deposition and sintering occurring layer by layer. In subsequent applications of the SIS technique to metals and ceramics, the SIS process relies on bulk sintering by outlining the part geometry with a ceramic or other material that does not sinter during the sintering cycle of the bulk material (e.g., the sintering temperature is much higher than that of the bulk material). The inhibitors are distributed with a nozzle as the powder-based substrate is deposited layer-by-layer prior to bulk sintering. Unlike the SIS process, which uses conventional radiative heating, various implementations described herein utilize microwave or RF heating for more rapid volumetric sintering. Also, various implementations use dopants to selectively absorb microwave/RF energy and enable sintering such that the surrounding powder bed remains unsintered and simply flows away from the part during breakout, whereas the SIS process sinters the entire powder bed, leaving sintered structures around the part that must be removed.

Various combinations of material jetting and selective sintering may be selected as a potential path to volumetric sintering. In a fast material jetting process, dopants are printed into the base material powder in layer-wise fashion. The dopants are engineered to selectively absorb electromagnetic radiation—specifically, microwave or RF energy—such that parts sinter only where the dopants have been printed when exposed to the microwave or RF energy. The approach is similar to the HP Multi Jet Fusion™ and High Speed Sintering (HSS) technologies with respect to the use of dopants to selectively absorb infrared radiation, which reduces fabrication time by an order of magnitude relative to a conventional laser sintering machine. However, the form of the proposed electromagnetic radiation is very different. Whereas the Multi Jet Fusion™ and High Speed Sintering technologies use infrared or radiant energy, various implementations described herein use microwave and RF energy. The use of microwave and/or RF energy provides nearly another order of magnitude increase in fabrication speed, above and beyond the use of selectively printed dopants because it enables rapid volumetric sintering of entire parts.

Specifically, whereas a complex layer requires approximately 45 seconds to prepare and sinter in a commercial SLS machine, and HSS requires approximately 8 seconds to process the same layer, the method described in relation to FIG. 1 processes the same layer in 1-2 seconds because only material jetting is required (not IR heating or laser scanning) RF-induced volumetric sintering of a centimeter-scale object would require sintering time on the order of a minute for the entire part, resulting in an overall speed increase of at least 25 times faster relative to commercial SLS and 4-8 times faster relative to HSS.

Various implementations also include modeling the interaction between radio and microwave frequency fields and selectively doped powder beds. For example, the rate of volumetric heating and the temperature distribution in the powder bed may be modeled as a function of the magnitude and frequency of the electric field and the dielectric properties of the powder bed. Models provide estimates of the total time required for sintering, the degree of uniformity of the applied field throughout the doped region (associated with hot or cold spots), the temperature distribution throughout the powder bed (indicating the boundaries of sintered/melted regions), and the depth of penetration of the applied field, which governs the size limits on sinterable parts. For example, models may indicate that RF field strengths can sinter large centimeter-scale objects in seconds with highly uniform electric fields and depths of penetration on the order of tens of centimeters (indicating very low attenuation in plastic powders).

As background, the rate of volumetric heating, Q_{gen} (W/m³) depends on the square of the electric field magnitude (from the Poynting Power Theorem):

Q_{gen}=(σ+ωδ″)|E|² (1)

where: σ=electrical conductivity (S/m), ω=2πf angular frequency (r/s), ∈″=the imaginary electric permittivity (F/m) and E=electric field strength (V/m, rms). The resulting temperature rise in the doped base material powder is calculated from a first-law energy balance:

$$ρ c \frac{\partial T}{\partial t} = ∇ \cdot ( k ∇ T ) + {Q}_{gen} \qquad ( 2 )$$

where: ρ=density (kg/m³), c=specific heat (J/kg−K), T=temperature (° C.), and k=thermal conductivity (W/m−K).

The process depends on selective absorption from the applied electromagnetic fields in only the doped regions because the dopant has a much higher electric conductivity than base material powder. However, the geometry of the doped region creates electromagnetic boundary conditions that may result in uneven electric fields and uneven heating. The implication of this is that the electric field in the doped region is orders of magnitude lower than in the undoped surroundings, again, due to electromagnetic boundary conditions. The governing E-field boundary conditions are two, one each for the tangential (t) and normal (n) components:

E₁ₜ=E₂ₜ(jω∈₁)E₁ₙ=(σ₂+jω∈*₂)E₂ₙ (3)

where region 1 is in the surrounding, undoped, base material powder, and region 2 is the doped region, which may have a complex permittivity. As an example, a semiconducting sphere in a uniform electric field (E₁) has a convenient analytical solution for the interior electric field of the sphere (region 2) according to the Clausius-Mossati formula:

$${E}_{2} = \frac{3 j {ωɛ}_{1}}{2 j {ωɛ}_{1} + ( {σ}_{2} + j {ωɛ}_{2} )} {E}_{1} \qquad ( 4 )$$

Here, all of the losses in the doped region (region 2) are included in its effective electrical conductivity. According to this ratio, the electric field in the doped region is always smaller than that in the surrounding un-doped region, and its strength depends strongly on the electrical conductivity of the mixture, σ₂. The effective electric conductivity of the mixture can be controlled by the concentration of dopant, while the base material powder remains essentially lossless.

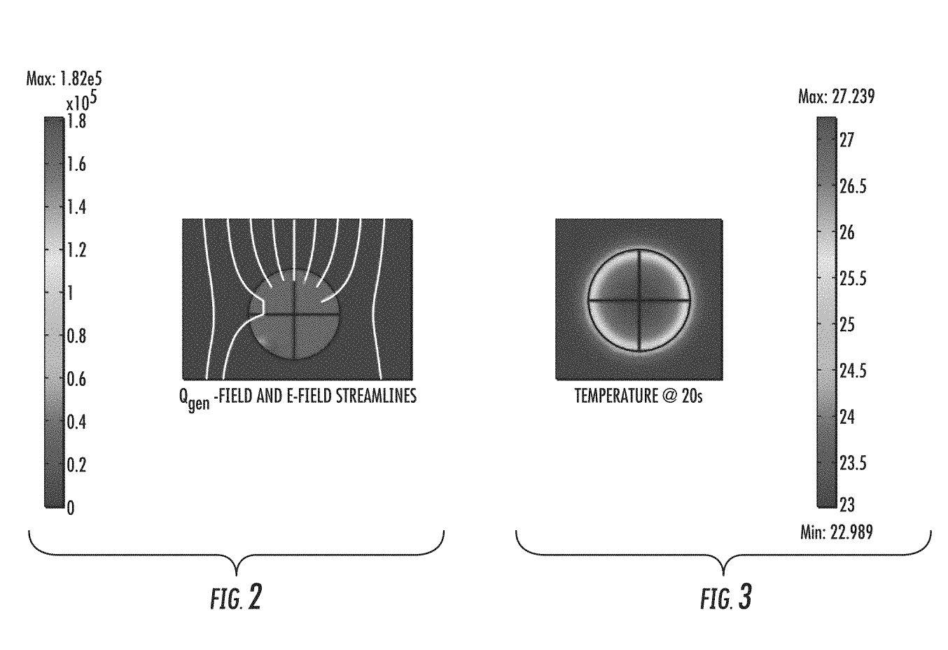

For example, an FEM numerical model has been constructed in the finite element software COMSOL 3.5 using the AC-DC (quasi-static electric field) Module for RF experiments and the RF (Wave propagation) Module for MW experiments. The expected temperature rise can be calculated for experiment conditions using the Heat Transfer module given Q_{gen}. Briefly, using property estimates based on the volume fraction of graphite as a dopant and Nylon 6 as a base material, a uniform electric field of 100 kV/m (rms) at a radio frequency of 27.5 MHz was applied to a 2 cm diameter sphere with σ=5 (S/m) and ∈′=20 ∈₀; the nylon was given ∈′=2 ∈₀ in a 20 cm×20 cm×10 cm tall box. The top and bottom surfaces were electrodes at T=23° C., with electrically insulating and thermal convection sides (h=5 W/m²−K). The volume packing factor for the nylon powder was estimated to be 63% (e.g., small spheres). Electrode voltages were +5 kV (rms). FIG. 2 illustrates the resulting heating term Q_{gen}=1.65×10⁵ (W/m³) of the sphere and e-field streamlines, and FIG. 3 illustrates the resulting temperature distributions. Using reasonable estimates for the thermal properties of the doped region (σ=5 S/m) means that the volume fraction of graphite is 0.01%; k_{eff}˜0.197 (W/m−K), ρ_{eff}˜724 (kg/m²), and c_{eff}˜1072 (J/kg−K) assuming Nylon 6 thermal properties. Based on Equations 1 and 2, the adiabatic temperature rise is expected to be 0.21 (° C./s), or 4.2° C. in 20 s, resulting in sintering/melting temperatures in approximately 13 minutes, and the numerical thermal model results agree with this prediction. Lowering the conductivity of the doped powder results in larger heating rates and faster temperature rises. Simple parameter sweeps in COMSOL indicate that Q_{gen} can be increased by two orders of magnitude by lowering the effective conductivity: at σ=0.05 (S/m) Q_{gen}=1.09×10⁷ (W/m³) and the estimated adiabatic dT/dt=14 (° C./s). At this effective electric conductivity the depth of penetration in the loaded region would be 30.6 cm at 27 MHz (RF) electric field. The modeling suggests that melting/sintering times on the order of a minute are reasonable for a cm-scale part, compared with sintering times of an hour in commercial SLS systems.

The appropriate dopant concentration may be significantly different for RF and microwave fields. The engineering trade-off is among depth of penetration (which decreases with the effective conductivity of the doped powder), heat transfer boundary conditions (which result in electric field strength that decreases with the effective conductivity of the doped powder), and heating rate (which increases with the effective conductivity of the powder and the square of the magnitude of the electric field strength). In addition, the electromagnetic heating is essentially open-loop since temperature feedback, while practical in laboratory experiments, may be impractical in routine use.

As shown in FIGS. 2 and 3, the electric field outside the sphere and the uniformity of the temperature distribution within the sphere are uniform. The RF problem is quasi-static, which means that the electric field is assumed to be uniform in the undoped region, because the expected dimensions of the model space (cm) are small compared to the ISM RF wavelengths (at 27 MHz, λ=11 m in free space). The microwave (2.45 GHz) problem may require wave solutions, which means that the electric field is assumed to be nonuniform due to constructive and destructive interference of the waves throughout the powder bed, if the problem dimensions are on the order of the microwave wavelengths (at 2.45 GHz, λ=12.2 cm) in free space.

Using the modeling described above, the types of base materials and dopants, volume fractions of dopants in the selectively sintered regions, and electric field frequency, strength, and duration of exposure can be selected based on the part to be manufactured. In addition, the modeling may also assist with estimating important metrics such as sintering times and energy consumption as a function of process variables and material compositions.

Variables that are considered in part design and process design may include various dopant and material compositions and mixtures; part volume and geometry; and electric field type (RF versus microwave), strength, and duration of exposure. In addition, sintering time, total energy consumption, and degree of controllability of the geometry of the processed parts (due to sintering-induced shrinkage and potential oversintering of doped regions of the powder bed resulting in undesirable part growth) may be considered.

The effective electrical conductivity (e.g., for RF fields) of the mixtures may be measured using an impedance analyzer, for example, and the effective loss factor (σ+ω∈″) (e.g., for MW fields) may be measured using a network analyzer. This data may be used in the computational models described above to allow the model-based predictions to more accurately inform the design process.

Heating rate and solidification experiments may be conducted at both RF and MW frequencies in fixtures that are already available for this type of application. Capacitive plates and coaxial chambers may be used for RF-induced heating and sintering/melting experiments, and waveguide applicators and resonant and multimode cavities may be used for the microwave experiments. Other variables may include the type of materials and dopants; the volume fraction of dopants; the frequency (RF or microwave), magnitude, and duration of the applied field; and the size and geometry of the representative part to be sintered. Measured responses may include the depth or extent of sintering, the accuracy of the shape and dimensions of the resulting part, the speed of the process, and its energy consumption (given that volumetric heating is typically more energy efficient than radiant heating). In addition, temperature measurements can be obtained with point contact optical temperature sensors (for sub-threshold, unmelted specimens) and with an X-band microwave (ca. 10 GHz) radiometer developed for harsher temperatures. The radiometric measurement may be limited to a single voxel on the order of the size of typical test shapes (cm), so it is more indicative than quantitative, but it can be calibrated with point-contact optical sensors to improve its accuracy. Sample parts, such as tensile bars, may also be fabricated for material property testing.

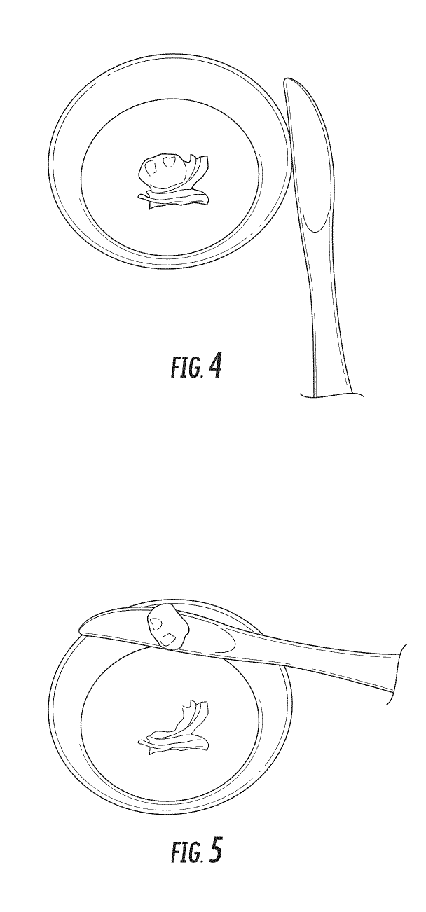

As shown in FIG. 4, a small sample of approximately 250 mL of nylon 12 powder, intended for selective laser sintering applications (50 μm particle diameter), was spread uniformly across the bottom of a ceramic crucible approximately 10 cm in diameter. Approximately 15 mL of nylon 12 powder was mixed with approximately 1 mL of graphite powder, and the mixture was deposited on top of the layer of pure nylon 12 in the center of the crucible. The sample was processed in a commercial kitchen microwave (600 W nominal at 2.45 GHz) for 140 seconds. Only the doped material in the center of the crucible sintered, resulting in a solid mass with a diameter of approximately 2 cm, as shown in FIG. 5. Surrounding nylon 12 powder was unsintered and flowed freely. More accurate placement of dopants, combined with optimized dopant volume fractions (e.g., which may be informed from the modeling described above) and application of more uniform and tightly controlled electric fields via laboratory-based RF and microwave generators may yield larger parts with shorter processing times and more tightly controlled part geometries.

The microstructure and mechanical properties of the three dimensional parts produced using the method of FIG. 1 may be evaluated using various methodologies. For example, mechanical properties, including density, strength, and ductility, may be correlated with process variables, including dopant type, dopant concentration, field strength, field frequency, and duration of exposure.

The evaluation of parts produced in this research falls into two categories: microstructure and (mechanical) properties. The evaluation includes characterization of the impact of the process itself on the material and part characterization. The former addresses process issues, such as parameter settings for optimum processing in terms of quality measures such as porosity. The latter provides an indication of the service performance of the parts created using volume manufacturing.

The interaction volume of melted polymer and the energy source may be assessed by doing post-process cross sectional cuts of parts and analyzing them optically. The features explored may include micro-porosity, macro-porosity and residual evidence of prior particle boundaries. Local density measurements provide a larger statistical sample of the porosity compared to optical observations, but the optical observations provide insight into the size, shape and distribution of the porosity if present. Density measurements may include an Archimedes technique and gas pychnometry. The Archimedes technique uses measurement of a liquid buoyancy force to back calculate the sample volume. Then, simple weighing of the sample provides the mass for the density calculation. Gas pychnometry uses a gas instead of a liquid which removes capillarity complications between the sample and the liquid. The value of the Archimedes technique is that the apparent density is obtained, which is valuable for calculating the volume of porosity. Comparison of the apparent density to the value obtained by gas pychnometry provides insight into the degree of connectivity of the porosity in three dimensions.

The degree of particle melting, which can impact part properties, may also be evaluated. These measurements may be made in an attempt to characterize the amount of melting within a particle, which itself provides a measure of strength and provides insight into the thermal history locally.

As the part geometry becomes more complex, the optical density and degree of particle melt observations may be taken at critical spots on the samples to assess the degree of variation that occurs due to changes in the geometry.

The effectiveness of a decoupling agent may be assessed by analyzing the powder surrounding parts after the build. This may be done by scanning electron microscopy (SEM) of the powder. SEM may be used to determine the degree of particle necking which is the first stage of sintering. If the part cakes into a mass that is friable, measurement of the compressive crushing load may provide an additional measure of the degree of bonding.

The mechanical properties of polymer parts are important and define the service regime. Strength and ductility are standard measures. ASTM D638 specimens may be used for this assessment. The variation of strength and ductility in the build plane and out of the build plane may be assessed. The toughness of parts produced using the volume printing approach is also an important property, as it is considerably more sensitive to defects than the strength. Toughness may be assessed using compact tension specimens per ASTM D5045.

Baseline comparisons may be made by duplicating the property assessments on parts produced using laser sintering and injection molding. In both cases, it is possible to use the same feedstock used for the volumetric sintered parts.

Alternative materials may be considered for use in this method. For example, an appropriate library of base materials and dopants for microwave/RF-induced volumetric powder bed fusion may be identified. Given the unique volumetric nature of the sintering described herein, the process may be suitable for a wide range of base materials that are not commonly processed in conventional powder bed fusion machines.

For example, polymers for powder bed fusion have three basic characteristics. First, they are semicrystalline, with sharp melt points. Second, the temperature difference is large between the melt point on heating and the crystallization temperature on cooling. Third, the melt viscosity must be balanced such that the polymer flows well when melted but does not infiltrate into the powder bed. Commercially active laser sintered materials include polyamide (nylon), PEEK, and polypropylene. Polymers for material extrusion on the other hand are amorphous. They form a “slushy” melt paste with high viscosity composed of mixed solid and liquid components. This allows the material to be placed by the nozzle into free space without undesired spreading or flow. The typical materials extrusion polymers are all amorphous and include, for example, polylactic acid, ABS, polycarbonate, polyetherimide (ULTEM®), and polystyrene.

Volume AM as described herein has a different set of rules in terms of feedstock requirements. The volume being simultaneously processed should exhibit low shrinkage to minimize in-process distortion. Melt viscosity should be controlled, as too low viscosity may result in loss of part shape while too high viscosity may cause insufficient flow for particle bonding. Success in volume AM may be achieved by using an approach similar to that used in laser sintering. In this case, the feedstock is heated, and the region surrounding the part is held at a temperature above the crystallization temperature but below the melt point. Thermal stress is effectively eliminated, which results in minimal in-process part distortion. On the other hand, there may be features of volume processing that mitigate residual stress formation, enabling amorphous plastics to be processed well. Amorphous polymers processed using volume AM may produce high-density parts, which is not possible with current material extrusion approaches. Processing amorphous polymers using volume AM may have a significant impact on the quality and performance of these parts and may expand the application space for amorphous plastics.

As described above, an exemplary dopant for heat coupling is graphite. It is inexpensive, nontoxic and easily available in powder form. It has high electrical conductivity and couples well to microwave and RF. Another exemplary dopant material is iron. It has similar features, and it is readily available in powder form (<45 microns) as it is used in the food industry for iron-enriching, particularly bread. Another advantage of iron is that it is feasible to assume that for whatever reason it becomes desirable to separate the dopant from the matrix material, the iron could easily be removed magnetically. Its electrical conductivity is higher than graphite, and it is cheaper on a volume basis. Aluminum is another exemplary dopant. It is superior to graphite in terms of electrical conductivity and cost on a volume basis, and it couples well to microwaves. For example, foil lined heating pocket “crispers” for microwave foods are lined with aluminum. Commercial nylon-aluminum powder mixtures are available. Other relatively low-cost, high electrical conductivity candidates for dopants include calcium, cadmium, and copper, for example.

The materials and/or binder jetting process may be developed to selectively deposit dopants into the base material powder bed. An exemplary goal of this process is selective deposition of dopants with high degrees of accuracy in placement and concentration. Depending on the degree of oversintering observed in experiments, selective deposition of inhibiting agents may be required near the edges of the parts.

An exemplary inhibiting agent is alumina, but other inhibitors may be used that are microwave transparent (electrically insulating) with high thermal mass (product of density and specific heat) and high thermal conductivity to draw away heat. Other exemplary inhibitors include diamond and sapphire (good performance but relatively expensive), beryllia (has some safety issues associated with this oxide, which is a known carcinogen and cause for berylliosis, particularly in powder form), aluminum nitride, and magnesia. Other inhibitors may include those used in selective inhibition sintering. For example, water-based salt solutions, powdered sugar, and salt are candidates that have the advantage of being water soluble to facilitate removal for refreshing purposes.

The dopants may be deposited by ink jet technology into the powder bed, for example. This involves jetting onto the powder bed an ink, which consists primarily of a carrier fluid, dopant/inhibitor, and possibly a surfactant to control surface tension. The ink is then be deposited in the form of small droplets of around 50 micron diameter and spread into the powder bed both laterally and vertically. The carrier fluid then needs to be adsorbed and evaporated, leaving behind the dopant/inhibitor within the powder. However, this seemingly simple process raise a number of issues.

Several possible combinations of carrier fluids and dopant/inhibitor may be suitable to enable absorption of microwaves. The carrier fluid affects the ability to form droplets and determines the time before a new layer of powder can be deposited based on the carrier fluid's evaporation rate. In many printing processes, there is enough time for the ink to dry on the surface of the substrate. However, in this process the carrier fluid must evaporate as soon as possible so that it does not build up and remain in place during the microwave sintering process, as this could lead to localized boiling and therefore uneven heating and movement of the powder.

The main physical properties of the ink to enable droplet generation are viscosity (normally less than 20 mPa·s), surface tension (normally 20 to 70 mNm₋₁) and density (de Gans et al. 2004). The most common situation where particles are printed with a carrier fluid is in the printing of silver loaded inks to generate 2D printed circuits. In this situation the ink remains on the surface of a (semi) solid substrate and evaporation of the carrier fluid leaves behind the silver nano-particles. This technique has been used to produce conductive tracks within 3D printed plastic parts. However, conventional silver loaded inks are not suitable because the evaporation of the solvent is much too slow and leads to a long delay before the next layer can be printed. Therefore, inks have been developed with much faster evaporation rates. These faster evaporation rates could be important where the solvent is expected to evaporate, even though evaporation may occur from a powder bed more quickly than a solid surface. It is possible to predict to some extent the ability of an ink to be jetted by calculating the Z number where Z=1/Oh [Oh=√We/Re] and We is the Weber number and Re is the Reynolds number. An ink is normally considered to be suitable for jetting, if the Z number is in the range 2≦Z≦14. There is usually a considerable amount of experimental work to then determine if an ink can be stably jetted and, if so, the optimum jetting parameters for a given head.

The dopant/inhibitor material, concentration, and particle size have a large effect on the ability to jet the ink. For example the nozzle diameter on most print heads ranges from 40 to 60 microns and solid particles within the ink must be less than 5% of the nozzle diameter, otherwise clogging becomes a problem. The various combinations have very different Z numbers and printability.

The variability of dopant/inhibitor concentration within the powder bed may be adjusted based on the interaction between the ink and powder bed and the printing parameters, such as droplet speed and overlap as well as the stability of the ink formulation.

The powder recoating technique and speed influence the powder bed density and resulting diffusion of the ink through the powder and the uniformity of dopant/inhibitor distribution. Thus, how the diffusion of the ink varies with the powder bed density is considered.

Various implementations may include a volumetric powder bed fusion system that provides for the selective deposition of base material powders and dopants with a microwave/RF-induced sintering station. Metrics include cost, size, throughput, and energy consumption.

Higher speed throughput of part production is a feature of the methods described herein. The resulting manufacturing system achieves this higher speed by taking the factors described above into consideration. The basic functionality of the manufacturing system can include the following main functions: (1) layer by layer formation of a selectively doped powder bed, (2) heating and sintering of the doped portion of the bed with relatively long electromagnetic (micro or radio) waves, and (3) breaking out the sintered part from the powder bed.

The manufacturing system may include, for example, a single integrated machine that does all three of these functions, or it could include separate systems. The latter approach may allow each function to be optimized for higher throughput. For example, the system may include a build platform on which the base material powder is deposited, a dopant dispenser (e.g., an ink-jet printer), as described above, for depositing the dopant onto each base material powder layer, an electromagnetic protected cage or enclosure and an electromagnetic wave generator to heat and sinter the doped powder bed, and a vacuum system for removing unsintered powder from the formed part. In some implementations, the system may include a build container that includes the build platform and the base material powder. The build container assists in transportation of the base material powder layers and/or the selectively doped powder layers. For example, the build container may be moved between an area adjacent the dopant dispenser for depositing the dopant onto each layer of base material powder and an area adjacent a base material powder dispenser for depositing base material powder layers into the build container. In addition, the build container may be moved to an area within the electromagnetic protected cage and adjacent the electromagnetic wave generator to allow the selectively doped layers to be heated and sintered. Alternatively or additionally, the dopant dispenser and/or the base material powder dispenser may be moved toward the build container for depositing dopant and/or base material powder. And, in an alternative or further implementation, the electromagnetic wave generator may be moved to an area near the build platform after the layers are deposited. Each of these portions of the system may be connected by a conveyor system, for example.

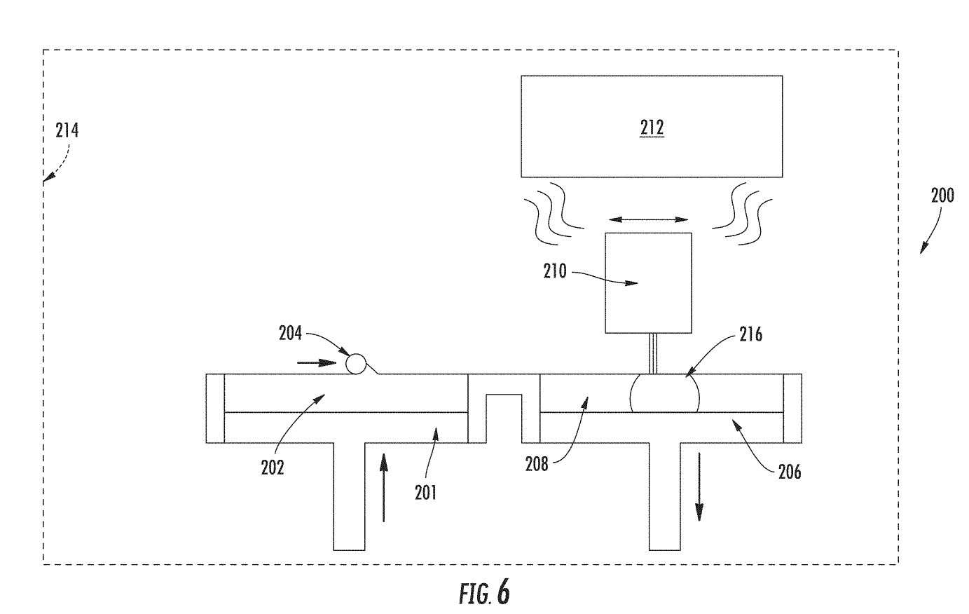

FIG. 6 illustrates a system for depositing the powder bed and dopant and sintering the part, according to one implementation. In particular, the system 200 includes a powder feed bed 201, powder feed 202 deposited on the powder feed bed 201, a powder spreader 204, a build platform 206, a powder bed 208 deposited on the build platform 206, a dopant dispenser 210 disposed above the powder bed 208 and build platform 206, a RF/microwave wave generator (or source) 212 adjacent the powder bed 208 and build platform 206, and a shielding enclosure 214 for keeping the RF/microwave radiation field within the shielding enclosure 214. To form the selectively doped powder bed, for each layer of the powder bed, the powder feed bed 201 is displaced upwardly, the build platform 206 is displaced downwardly, and the powder spreader 204 moves pushes an upper layer of powder 202 over to the build platform 206 or the uppermost layer of powder 208 deposited thereon. The amount of movement up and down depends on the thickness of the powder bed layer being moved by the powder spreader 204. Then, the dopant dispenser 210 deposits dopant on the portions of the powder bed layer that are to be part of the part to be formed. These steps are repeated until the selectively doped powder bed is completed. The selectively doped powder bed includes the volume of the part to be formed. Next, the RF/microwave wave generator 212 transmits radiation toward the selectively doped powder bed, which results in heating and sintering of the doped portion into the part 216. After the part 216 is formed, the part is removed from the powder bed 208. As noted above, the unsintered powder may be removed manually from the part or by using a pressurized fluid.

Various modifications of the devices and methods in addition to those shown and described herein are intended to fall within the scope of the appended claims. Further, while only certain representative devices and method steps disclosed herein are specifically described, other combinations of the devices and method steps are intended to fall within the scope of the appended claims, even if not specifically recited. Thus, a combination of steps, elements, components, or constituents may be explicitly mentioned herein. However, other combinations of steps, elements, components, and constituents are included, even though not explicitly stated. The term “comprising” and variations thereof as used herein is used synonymously with the term “including” and variations thereof and are open, non-limiting terms.

1. A method of producing a three-dimensional part using additive manufacturing comprising:
depositing a first layer of base material powder adjacent a support surface, the base material powder being substantially transparent to electromagnetic radiation; depositing a dopant onto one or more selected areas of the first layer of base material powder, the one or more selected areas being areas for which fusion of the base material powder is desired, wherein the dopant absorbs electromagnetic radiation;
depositing one or more additional layers of base material powder until a desired height of the three-dimensional part is achieved, wherein the dopant is deposited on each layer in one or more selected areas for the respective layer for which fusion is desired; and
exposing the layers of base material powder and dopant to an electromagnetic radiation field, the electromagnetic radiation field having a wavelength frequency of between 3 kHz to 300 GHz, wherein the electromagnetic radiation field sinters the one or more selected areas of the base material powder layers on which the dopant is deposited to create the three-dimensional part.

2. The method of claim 1, wherein the base material powder on which dopant is not deposited remains unsintered after exposure to the electromagnetic radiation field, and the method further comprising freely removing the three-dimensional part from the unsintered base material powder after exposing the base material powder and dopant to the electromagnetic radiation field.

3. The method of claim 2, wherein freely removing the unsintered base material powder comprises vacuuming the unsintered base material powder away from the sintered three-dimensional part.

4. The method of claim 2, wherein freely removing the unsintered base material powder comprises directing a pressurized gas toward the unsintered base material powder to blow the unsintered base material powder away from the sintered three-dimensional part.

5. The method of claim 1, wherein a concentration of dopant is graded along edges of the part such that the graded areas are warmed during exposure to the electromagnetic radiation field but are not sintered.

6. The method of claim 1, wherein the base material powder comprises a polymer powder.

7. The method of claim 1, wherein the base material powder comprises glass fiber.

8. The method of claim 1, wherein the dopant is not applied to all areas of the base material powder.

9. The method of claim 1, wherein the dopant is selected from the group consisting of: carbon black, iron, and aluminum.

10. The method of claim 1, wherein depositing the dopant comprises printing the dopant onto one or more base material powder layers using an ink-jet printing process.

11. The method of claim 1, wherein a dissipation factor of the base material powder is 0.002 or less.

12. The method of claim 1, wherein the dopant increases the dissipation factor of the base material powder on which the dopant is deposited to at least 0.04.

13. The method of claim 1, wherein the wavelength frequency of the electromagnetic radiation field is between 300 MHz and 300 GHz.

14. A system for producing a three-dimensional part using additive manufacturing, the system comprising:
a build platform on which a base material powder is deposited layer by layer;
a dopant dispenser comprising a dopant; and
an electromagnetic wave generator,
wherein:
the base material powder is substantially transparent to electromagnetic radiation,
the dopant absorbs electromagnetic radiation,
the dopant dispenser is configured to deposit the dopant onto selected areas of an upper layer of the base material powder for which fusion is desired,
the electromagnetic wave generator is configured to transmit an electromagnetic radiation field to a plurality of layers of base material powder and dopant, the electromagnetic radiation field having a wavelength frequency of between 3 kHz to 300 GHz, and
the electromagnetic radiation field sinters the one or more selected areas of the base material powder layers on which the dopant is deposited to create the three-dimensional part.

15. The system of claim 14, further comprising:
a powder feed bed on which the base material powder is disposed prior to be deposited onto the build platform, the powder feed bed being movable vertically, and the powder feed bed being disposed adjacent the build platform, and
a powder spreader, the powder spreader being movable horizontally between the powder feed bed to adjacent the build platform to move each layer of base material powder from the powder feed bed to the build platform or the upper layer of powder bed of the base material powder deposited on the build platform,
wherein the powder feed bed is movable upwardly and the build platform is movable downwardly by a height of each layer of base material powder ahead of the powder spreader moving each layer from the powder feed bed toward the build platform.

16. The system of claim 14, wherein a height of the plurality of layers of base material powder and dopant are a desired height of the three-dimensional part.

17. The system of claim 14, wherein the base material powder on which dopant is not deposited remains unsintered after exposure to the electromagnetic radiation field.

18. The system of claim 14, wherein the dopant dispenser is disposed above the build platform.

19. The system of claim 14, wherein the electromagnetic wave generator is disposed adjacent the build platform.
